(19) United States
(12) Patent Application Publication
(10) Pub. No.: US 2023/0176576 A1
(43) Pub. Date: Jun. 8, 2023

(54) SYSTEMS AND METHODS FOR MANAGING TRAFFIC LIGHT BEHAVIORS

(71) Applicant: Motional AD LLC, Boston, MA (US)

(72) Inventor: Marco Mandrioli, Singapore (SG)

(21) Appl. No.: 17/541,147

(22) Filed: Dec. 2, 2021

(51) Int. Cl. G05D 1/00; B60W 10/20

(52) U.S. Cl. CPC G05D 1/0088; B60W 10/20; B60W 2420/52; B60W 2554/4046

(57) ABSTRACT

Provided are methods for managing behaviors of traffic lights, including: obtaining, using at least one processor, information corresponding to an area of interest including two or more road blocks, each road block being associated with a plurality of physical traffic lights configured to control traffic movements associated with the road block; for each of the two or more road blocks, generating, using the at least one processor, a logical traffic light that represents a grouping of the plurality of physical traffic lights; and determining, using the at least one processor, one or more characteristics of each logical traffic light based on the information corresponding to the area of interest. Systems and computer program products are also provided.

### BACKGROUND

In making decisions near an area of interest (e.g., an intersection), a system can consider behaviors of individual physical traffic lights at the area of interest. However, this can be cumbersome and prone to inconsistencies, mistakes or error handling, and inefficiency, especially when there are a large number of physical traffic lights governing traffic movement at the area of interest.

### BRIEF DESCRIPTION OF THE FIGURES

FIG. 1A shows an example intersection with physical traffic lights.

FIG. 1B shows an example of logical traffic lights representing the physical traffic lights at the intersection of FIG. 1A.

FIGS. 2A-2C illustrate state changes of the logical traffic lights of FIG. 1B at the intersection of FIG. 1A.

FIG. 3 is a diagram of an example finite state machine (FSM) showing states of an intersection.

FIG. 4 is a flowchart of a process for determining information of logical traffic lights.

FIG. 5 is an example environment in which a vehicle including one or more components of an autonomous system can be implemented.

FIG. 6 is a diagram of one or more systems of a vehicle including an autonomous system.

FIG. 7 is a diagram of components of one or more devices and/or one or more systems of FIGS. 5 and 6.

FIG. 8 is a diagram of certain components of an autonomous system.

FIG. 9 shows a block diagram of an architecture for managing traffic light behaviors for vehicles.

FIG. 10 is a flowchart of a process for managing traffic light behaviors for vehicles using information of logical traffic lights.

### DETAILED DESCRIPTION

In the following description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

### General Overview

A computing system is configured to simulate (or configure) traffic light behaviors at areas of interest (e.g., intersections) in a consistent, robust, and complete way for reliable and efficient decision making. Specifically, the computing system groups/aggregates a number of physical traffic lights controlling a same road block (e.g., a same incoming road block) at an area of interest into a single, logical traffic light. The computing system uses a finite state machine (FSM) that is defined by a series of states to determine the state of the area of interest (e.g., to determine the states of logic traffic lights controlling the road block(s) at the intersection). Each state of the FSM representing the state of the area of interest is determined by possible permutations and combinations of the states of the group(s) of logical traffic lights for road blocks in the area of interest. The computing system can determine an area of interest to be in a specific state in response to a trigger (e.g., a distance trigger or a time trigger). The computing system can transition the area of interest in a state loop formed by multiple states, and transition the logical traffic lights associated with the area of interest into states corresponding to a corresponding state of the area of interest. The computing system can simulate behaviors of the logical traffic lights at the area of interest in response to different traffic conditions, and adjust properties of physical traffic lights in the real world corresponding to the logical traffic lights, e.g., a duration of each state (such as Green, Yellow, Red), a location, or a number of the physical traffic lights.

In some aspects and/or embodiments, systems, methods, and computer program products described herein include and/or implement managing traffic light behaviors. A database stores a data structure associating each area of interest with logical traffic light groupings of the physical traffic lights at the area of interest, and corresponding states for the logical traffic light groupings, without storing information about a large number of physical traffic lights. Logical traffic lights for road blocks in area of interests can be provided for visualization using graphical interfaces.

By virtue of the implementation of systems, methods, and computer program products described herein, techniques for managing traffic light behaviors have some advantages as follows. First, the techniques can use a single logical traffic light to represent a larger number of physical traffic lights (e.g., two or more traffic lights per road block; can be a larger number such as 5, 10 or 20) for a road block at an area of interest (e.g., an intersection) and use a series of states for the area of interest to determine traffic light behaviors at the area of interest, which can facilitate determining behaviors of all the traffic lights in a simple, consistent, robust, and complete way for reliable and efficient decision making. In contrast, determining the state of the area of interest based on individually determining the states of each of several physical traffic lights can be cumbersome, especially if there are a large number (e.g., 5, 10 or 20) of physical traffic lights governing traffic movement at a roadblock; this can cause inconsistencies, mistakes or error handling, and inefficiency. Second, the techniques enable to simulate behaviors of logical traffic lights at the area of interest in response to different traffic conditions, and configure physical traffic lights in the real word based on a result of the simulation, which can be more effective, accurate, reliable, and cost-efficient. Third, the techniques enable to simulate a behavior of a vehicle along a route including one or more areas of interest or behaviors of vehicles across a particular area of interest, which can be used for route planning or scheduling. Fourth, the techniques enable to store information of logical traffic lights at road blocks or states of areas of interest (e.g., intersections) in a database, without storing information of the larger number of physical traffic lights individually, which can greatly save storage space, simplify the storage process, and use less communication and/or computing resources, e.g., to update when a map is edited. Fifth, the techniques can manage traffic light behaviors at an intersection level, instead of at an individual physical traffic light level, which can be easier to edit, update, and expand to multiple levels (e.g., a route level or a region level). Sixth, the techniques can ensure that the states of all the physical traffic lights and all roadblocks at an intersection are consistent with one another, and transition together at the same time. Seventh, the techniques can display single logical traffic lights, instead of a larger number of physical traffic lights, for areas of interest using graphical interfaces, which can greatly simplify the visualization and make it easier to view and understand.

### Example Techniques for Managing Traffic Light Behaviors

Implementations of the present disclosure provide techniques for managing traffic light behaviors using logical traffic lights at areas of interest (e.g., intersections). The techniques can be implemented by a computing system that includes one or more computing devices, for example, in a simulation environment. The computing system can simulate behaviors of physical traffic lights at areas of interests using corresponding logical traffic lights, and adjust properties of the physical traffic lights in a virtual world (e.g., simulation program or application) or a real world. The computing system can also simulate behaviors of vehicles across areas of interests using corresponding logical traffic lights, and adjust properties of the physical traffic lights in the virtual world or the real world, and/or adjust operations and/or routes for the vehicles in the virtual world or the real world. In some cases, the techniques can be implemented in a vehicle system, enabling the vehicle system to maneuver movement through intersections in the real world.

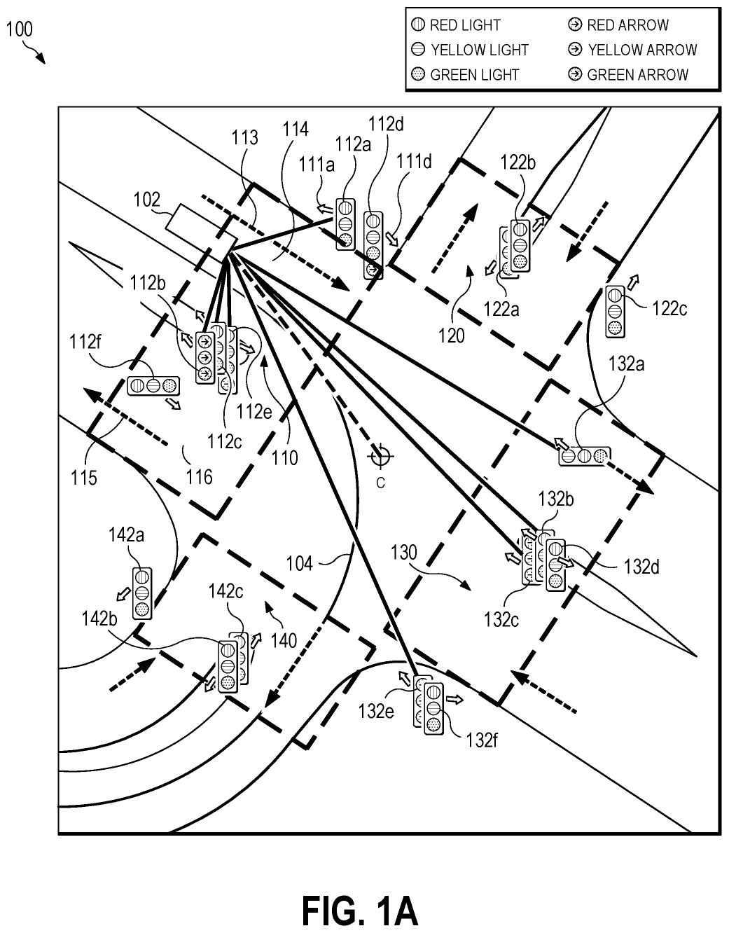

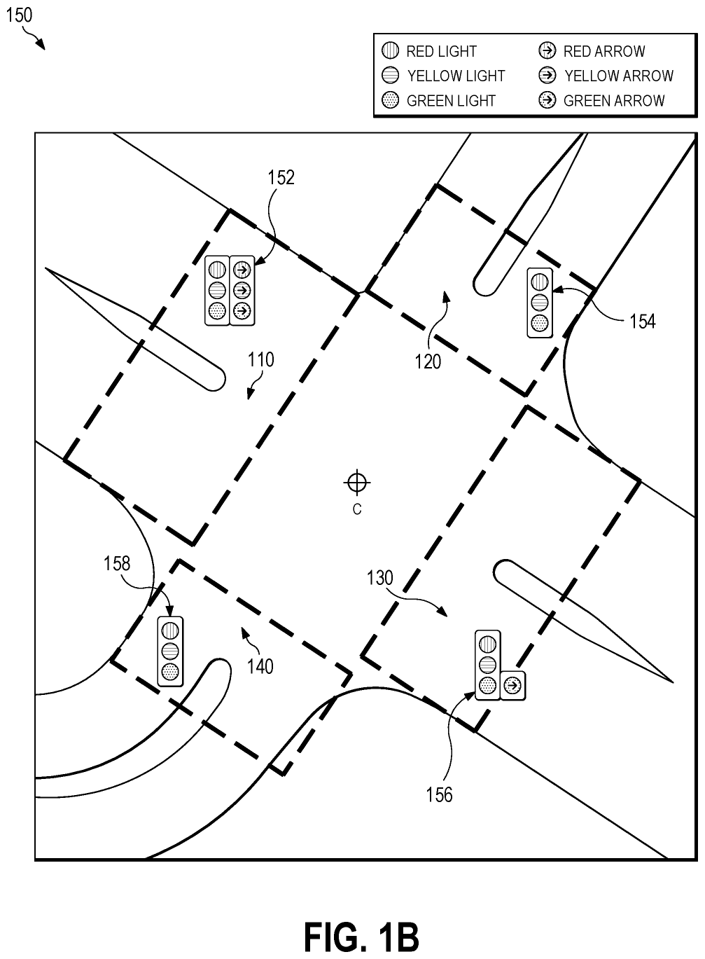

FIG. 1A shows a schematic diagram of an example intersection 100 in a map. In some embodiments, the intersection 100 is a representation of an intersection that is traversed by a vehicle, and corresponds to an area of interest for the vehicle. For example, in some cases, the intersection 100 is a visualization in a simulation environment executed by an application running on a computing system. As shown, the intersection 100 includes four road blocks 110, 120, 130, 140 around a center C (as illustrated by dashed boxes in FIGS. 1A-1B). Each road block represents an area included in the intersection and is associated with two roads, e.g., with opposite or angled road directions. Each road includes one or more lanes. As an example, the road block 110 is associated with a first road 114 with a first road direction 113 and a second road 116 with a second road direction 115. In some examples, the second road direction 115 is opposite to the first road direction 113. In some examples, an angle between the first road direction 113 and the second road direction 115 is larger than 0 degree and less than 90 degrees.

At (or around) each road block, there are one or more physical traffic lights positioned there and configured to control movement of traffic for the road block and one or more other road blocks. As illustrated in FIG. 1A, at (or around) the road block 110, there are six physical traffic lights 112a, 112b, 112c, 112d, 112e, 112f; at (or around) the road block 120, there are three physical traffic lights 122a, 122b, 122c; at (or around) the road block 130, there are six physical traffic lights 132a, 132b, 132c, 132d, 132e, 132f; at (or around) the road block 140, there are three physical traffic lights 142a, 142b, 142c. Each physical traffic light includes three light bulbs, e.g., red, yellow, and green. In one embodiment, a physical traffic light includes an arrow, e.g., a left arrow, a right arrow, an up arrow, or a down arrow. For example, the physical traffic light 112d includes a right arrow.

Each physical traffic light is positioned toward a road block for governing traffic (e.g., including vehicles and/or pedestrians) movement associated with the road block, e.g., from the road block. For example, arrow 111a shows that the physical traffic light 112a is positioned toward vehicles travelling on the road 114 associated with the road block 110, while arrow 111d shows that physical traffic light 112d is positioned toward the road block 130 for governing traffic movement associated with the road block 130. Thus, a road block can be associated with physical traffic lights positioned at the road block and also physical traffic lights positioned at one or more other road blocks at the same intersection 100, and the physical traffic lights are positioned towards the road block for governing traffic movement associated with the road block.

As illustrated in FIG. 1A, there are seven physical traffic lights (as connected by solid lines to a vehicle 102) positioned towards the road block 110 for regulating traffic movement of vehicles from the road block 110. The seven physical traffic lights include 112a, 112b, 112c, 132a, 132b, 132c, 132e. Among them, the physical traffic lights 112a, 112b, 112c are positioned at the road block 110, and the physical traffic lights 132a, 132b, 132c, 132e are positioned at the road block 130 facing the road block 110.

The vehicle 102 is travelling along a route, e.g., route 104, approaching the intersection 100 from the road block 110. To make a driving decision, in one embodiment, the vehicle 102 monitors behaviors of physical traffic lights governing traffic movement for the road block 110 at the intersection 100, that is, the seven physical traffic lights 112a, 112b, 112c, 132a, 132b, 132c, 132e, which can be cumbersome and prone to inconsistencies, mistakes or errors, and inefficiency.

To address the above issues, implementations of the present disclosure provide grouping (or aggregating) a number of physical traffic lights for a same road block at an area of interest (e.g., an intersection) into a single, logical traffic light. Behaviors of the physical traffic lights are represented by states of the single, logical traffic light. Thus, instead of making a driving decision based on the behaviors of the physical traffic lights, a vehicle can just rely on a current state of the single, logical traffic light.

FIG. 1B shows an example 150 of logical traffic lights representing the physical traffic lights at the intersection 100 of FIG. 1A. In some embodiments, the example 150 is a visualization in a simulation environment executed by an application running on a computing system. Each logical traffic light corresponds to a respective road block. For example, logical traffic light 152 for the road block 110 is an aggregation or grouping of seven physical traffic lights 112a, 112b, 112c, 132a, 132b, 132c, 132e. Similarly, logical traffic light 154 represents a grouping of a plurality of physical traffic lights governing traffic movement associated with the road block 120, logical traffic light 156 represents a grouping of a plurality of physical traffic lights governing traffic movement associated with the road block 130, and logical traffic light 158 represents a grouping of a plurality of physical traffic lights governing traffic movement associated with the road block 140.

In one embodiment, a logical traffic light includes a plurality of logical bulbs, e.g., one or more logical red bulbs, logical yellow bulbs, and/or logical green bulbs. Information of the logical traffic light includes information of each logical bulb. The information of a logical blub includes at least one of a shape (e.g., circle, right arrow, left arrow, up arrow, down arrow, or unknown), a color (e.g., red, yellow, green, or unknown), a state (e.g., on, off, flashing, or unknown), or a duration (e.g., 5s, 10s, or 20s). In an embodiment, a logical bulb for a logical traffic light corresponds to physical bulbs, among the plurality of physical traffic lights represented by the logical traffic light, that have at least one of a same shape, a same color, or a same state.

In one embodiment, a data structure storing data associated with a logical traffic light bulb in a database (e.g., in the computing system or in a remote server) is presented as below:

```
enum TrafficLightsBulbShape : ubyte {
  Circle,
  RightArrow,
  LeftArrow,
  UpArrow,
  Unknown
}
enum TrafficLightsBuIbColor : ubyte {
  Red,
  Yellow,
  Green,
  Unknown
}
enum TrafficLightsBulbState : ubyte {
  On,
  Off,
  Flashing,
  Unknown
}
table TrafficLightsBulb {
  shape : TrafficLightsBulbShape; // Shape of the bulb
  color: TrafficLightsBuIbColor; // Color of the bulb
  state : TrafficLightsBulbState; // State of the bulb
}.
```

In some embodiments, a vehicle approaching an intersection determines a current state of a logical traffic light for a corresponding road block by simulation using historical data (and/or other real time data) and a current time point. The simulation can also determine a remaining time for the current state of the logical traffic light. In an example, a state of the logical traffic light changes following a loop including red for 20 seconds, yellow for 5 seconds, green for 20 seconds. The historical data shows that at 8:00 AM, the state of the logical traffic light starts from red. Then, according to simulation, at 9:01 AM, the vehicle can determine the state of the logical traffic light to be red, and the remaining time for the red state to be 5 seconds; at 9:02 AM, the vehicle can determine the state of the logical traffic light to be green, and the remaining time for the green state to be 15 seconds.

In one embodiment, a data structure storing data associated logical traffic light (e.g., the logical traffic light 152) for a road block (e.g., the road block 110) in the database is presented as below:

```
table TrafficLightsRoadblock
{
  timestamp : long; // Timestamp
  RoadblockId; // ID of roadblock that can be a universally unique
              identifier (UUID) or a GeoPackage (GPKG) ID
  bulbs : [TrafficLightsBulb]; // List of bulbs with states
  remainingTime : double; // Remaining time for a current state
}.
```

In some embodiments, based on one or more of a current location of the vehicle, a route of the vehicle, and a current speed of the vehicle, the vehicle determines a current state of the logical traffic light when the vehicle arrives the intersection from the corresponding road block and what is the remaining time for the current state. Based on the current state and the time remaining in the state, the vehicle can determine which action to be taken by the vehicle, e.g., to stop, to slow down, to continue at a current speed, or to speed up the current speed.

At an intersection, a vehicle arrives from a road block (or labelled as an incoming roadblock or a from-roadblock), e.g., the road block 110, and there can be one or more outgoing roadblocks (or labelled as to-roadblocks), e.g., the road block 120, 130, 140. The vehicle may determine an operation based on logical traffic lights for the outgoing roadblocks.

In one embodiment, a data structure storing data associated logical traffic lights (e.g., 154, 156, 158) for an incoming road block and the outgoing roadblocks in the database is presented as below:

```
table TrafficLightsToRoadblock
{
  toRoadblockId; // ID of outgoing roadblock that can be a UUID or GPID
  bulbs : [TrafficLightsBulb]; // List of bulbs with states
}
table TrafficLightsFrom Roadblock
{
timestamp : long; // Timestamp
from RoadblockId; // ID of incoming roadblock that can be a UUID
                  or GPKG ID
toRoadblocks : [TrafficLightsToRoadblock]; // Outgoing roadblocks with
                                      bulbs
remainingTime : double; // Remaining time for current state
}
```

Traffic light behaviors associated with an intersection is an accumulation of logical traffic light behaviors for road blocks in the intersection. In one embodiment, a data structure storing traffic light data associated with intersection(s) in the database is presented as below:

```
table TrafficLightsIntersection
  {
    intersectionId; // ID of the intersection that can be a UUID or
                  GPKG ID
    from Roadblocks : [TrafficLightsFromRoadblock]; // List of from
                  roadblocks with associated traffic light data
  }
table TrafficLightsIntersections
  {
    intersections : [TrafficLightsIntersection]; // List of intersections
  }.
```

Traffic light behaviors at an intersection are represented by traffic light behaviors of logical traffic lights for road blocks in the intersection. States of the logical traffic lights for the different road blocks are consistent with one another and transition in a synchronized manner. A state of the intersection is represented by the states of the logical traffic lights. When the state of the intersection changes, the states of the logical traffic lights all transition to new states; while when a state of any one of the logical traffic lights changes, the state of the intersection changes (or moves) to a new state.

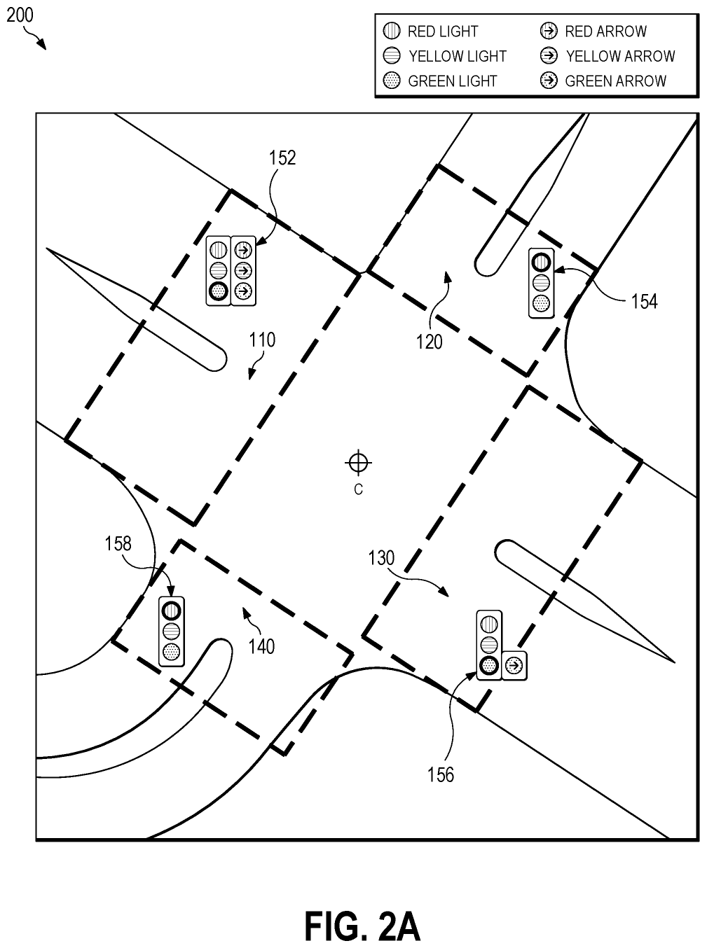

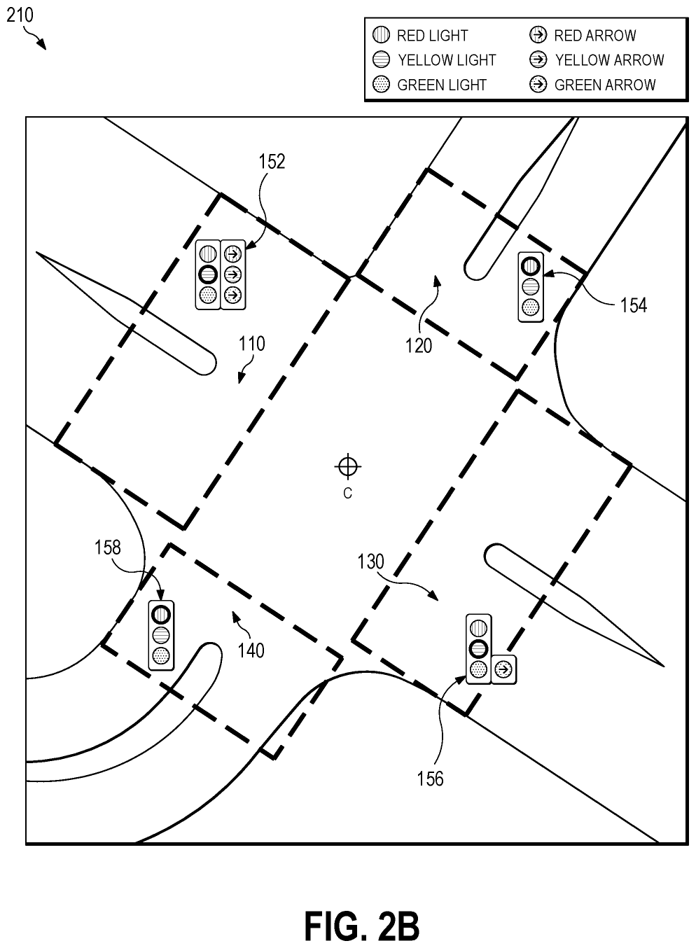

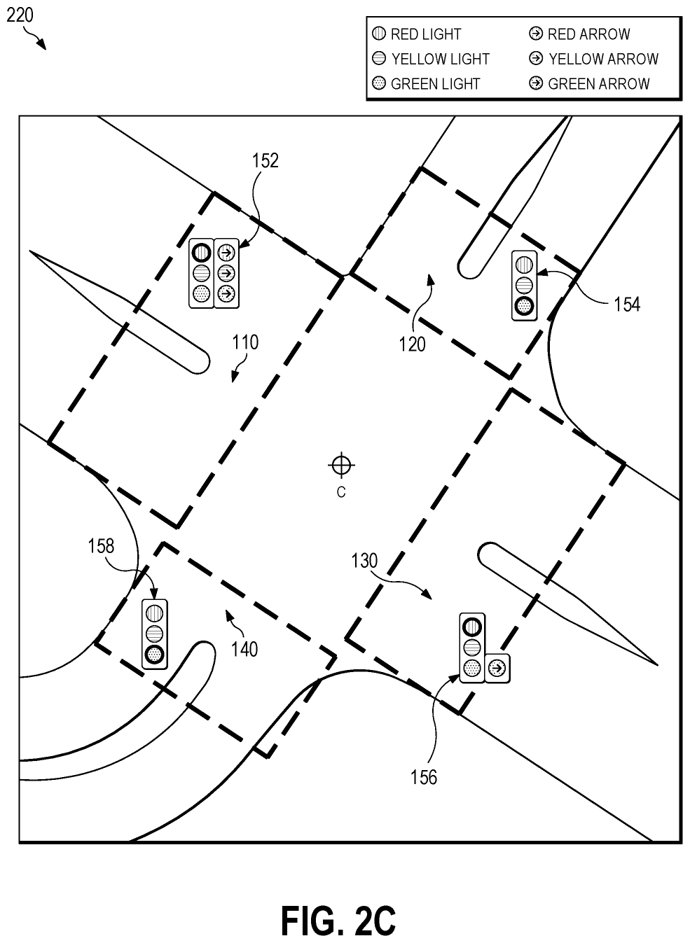

As an example, FIGS. 2A to 2C show states of the logical traffic lights 152, 154, 156, 158 for the road blocks 110, 120, 130, 140 at the intersection 100. FIG. 2A shows a first state 200 of the intersection 100, where green logical bulbs of the logical traffic lights 152, 156 are on and red logical bulbs of the logical traffic lights 154, 158 are on. FIG. 2B shows a second state 210 of the intersection 100, where yellow logical bulbs of the logical traffic lights 152, 156 are on and red logical bulbs of the logical traffic lights 154, 158 are on. FIG. 2C shows a third state 220 of the intersection 100, where red logical bulbs of the logical traffic lights 152, 156 are on and green logical bulbs of the logical traffic lights 154, 158 are off. In some cases, FIGS. 2A-2C are visualizations in a simulation environment executed by an application running on a computing system.

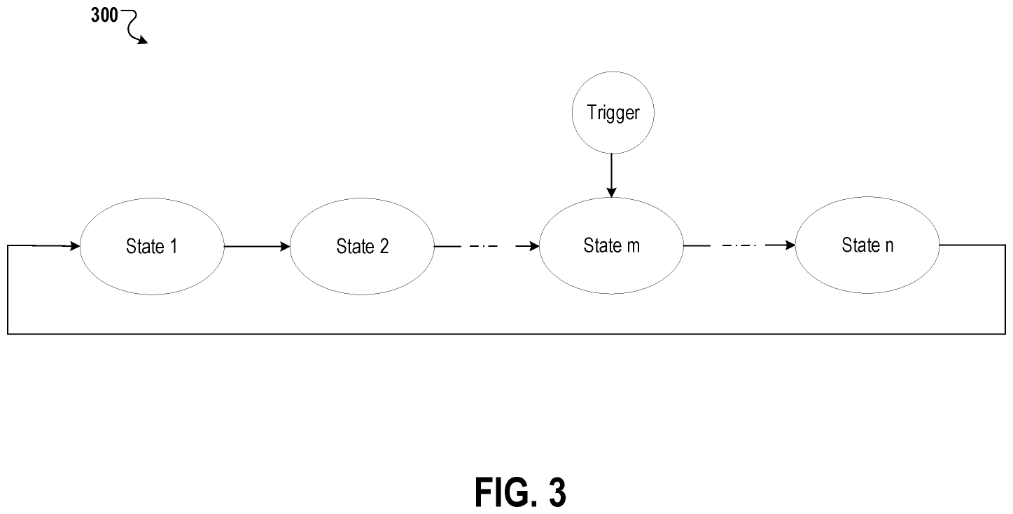

In one embodiment, states representing the behaviors of logical traffic lights at an intersection are represented by a finite state machine (FSM). FIG. 3 illustrates an example FSM 300. The FSM is defined by a finite number of states, state 1, state 2, . . . , state n, where n is an integer larger than 1. In some embodiments, the FSM is configured for a logic traffic light for a road block. In some embodiments, the FSM is configured for the intersection. Each state of the FSM is determined by combinations of states of logical traffic lights for road blocks in the intersection. A state of the FSM can be the first state 200, the second state 210, or the third state 220. For example, the FSM represents three states shown in FIGS. 2A-2C, where state 1 represents the first state 200 of FIG. 2A, state 2 represents the second state 210 of FIG. 2B, and state n represents the third state 220 of FIG. 2C. The states of the FSM form a loop (e.g., from state n back to state 1), and the state of the intersection sequentially moves into a next state according to the FSM at an end of a duration of a current state. The state of the intersection is in one of the states of the FSM at any given time. The FSM 300 can be used to maintain the whole intersection in a consistent state. For example, as shown in FIGS. 2A and 2B, from the first state 200 to the second state 210, only states of the logical traffic lights 152, 156 are changed, but the FSM moves the state of the whole intersection from the first state to the second state.

As an example, an intersection includes two road blocks, with two corresponding logical traffic lights. Durations for red, yellow, and green signals for logical traffic lights are 30 seconds, 5 seconds, and 20 seconds, respectively. The intersection has six states that can change as shown below. After state 6 ends, the intersection transitions into state 1 again.

| State | First logical traffic light | Second logical traffic light |
|---|---|---|
| 1 | Red for 20 seconds | Green for 20 seconds |
| 2 | Red for 5 seconds | Yellow for 5 seconds |
| 3 | Red for 5 seconds | Red for 5 seconds |
| 4 | Green for 20 seconds | Red for 20 seconds |
| 5 | Yellow for 5 seconds | Red for 5 seconds |
| 6 | Red for 5 seconds | Yellow for 5 seconds |

In one embodiment, the vehicle determines that the intersection transitions from a current state to a new state in response to an occurrence of a trigger event. The transitioned new state can be a state immediately following the current state in the FSM. In an embodiment, the trigger event is associated with a distance between the vehicle and the intersection. For example, the distance is a distance between a center of the vehicle and a center of the intersection, e.g., a length of a dash line from the vehicle 102 to the center C of the intersection 100 as shown in FIG. 1A. The trigger event can also be associated with a delay time, in addition or as an alternative to the distance. In an embodiment, the trigger event is associated with an expiration of a time period, e.g., after a simulation of traffic light behavior at the intersection starts.

In one embodiment, traffic light information of an intersection is stored in a database. In the database, an identifier of the intersection is stored and associated with multiple states. Each of the multiple states is associated with a respective duration of the state (e.g., 20 seconds, 10 seconds, or 5 seconds), identifiers of multiple road blocks at the intersection (e.g., incoming roadblock, outgoing roadblock, and/or other adjacent road blocks), and information of logical traffic lights associated with the multiple road blocks.

In one embodiment, a data structure storing traffic light data of intersections in the database is presented as below:

```
Intersection 1 // ID from the map
  FSM state 1
    Duration // how long the state will last
    Roadblock 1 // ID from the map, incoming road
      Logical bulb 1 (shape, color, state) // e.g., circle, red, flashing
      Logical bulb 2 (shape, color, state) //
      ...
    Roadblock 2 // ID from the map, incoming road
      ...
  FSM state 2
  ...
Intersection 2 // ID from the map
...
```

Traffic light data of intersections stored in the database can be visualized in a graphical interface. For example, instead of presenting physical traffic lights at the intersections (e.g., as shown in FIG. 1A) in a map (e.g., a digital map displayed on the computing system), logical traffic lights for road blocks at the intersections are used to define traffic light behaviors and presented in the map (e.g., as shown in FIG. 1B), which can reduce complexity and make it easier to view and understand. Moreover, as illustrated in FIGS. 2A-2C, the computing system can manage changes of states of traffic light behaviors of the intersections at an intersection level, which can be easier to edit, update, and expand to multiple levels, e.g., a route level or a region level. In one example, along a route traversed by a vehicle, the computing system can manage traffic light behaviors at multiple intersections along the route. In another example, in a region where the vehicle is, the computing system can manage traffic light behaviors at multiple intersection within the region.

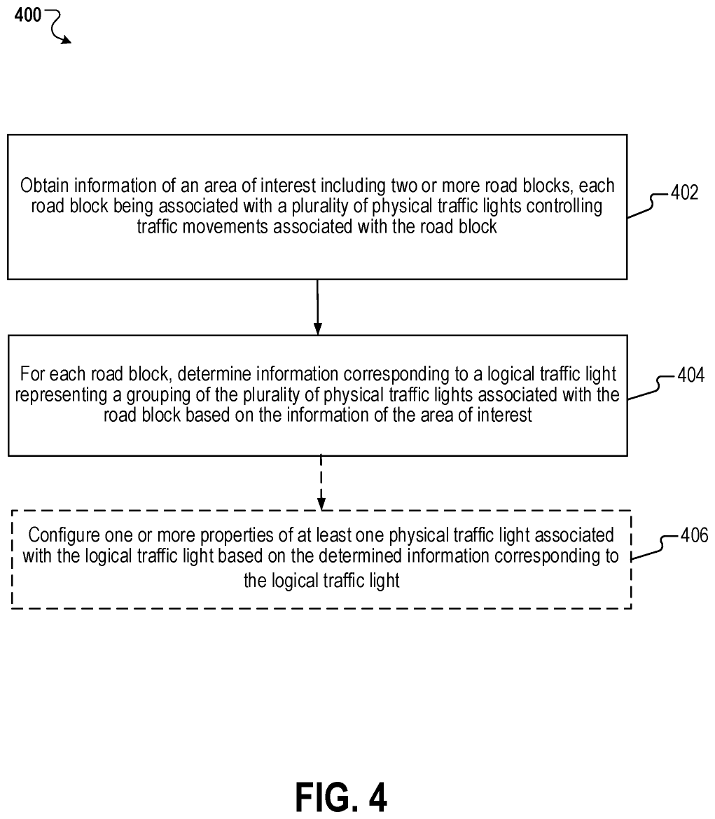

FIG. 4 is a flowchart of a process 400 for managing traffic light behaviors, particularly for determining information about logical traffic lights for road blocks at an area of interest. In some embodiments, the process 400 is performed (e.g., completely, partially, and/or the like) by a computing system including at least one computing device. The computing system can be in a server or in a vehicle system.

In the process 400, the computing system obtains information corresponding to an area of interest (402). In some embodiments, the area of interest includes an intersection with two or more road blocks. Each road block is associated with a plurality of physical traffic lights controlling traffic movements associated with the road block, e.g., vehicles from the road block entering the area of interest.

In some embodiments, the plurality of physical traffic lights are positioned at two or more different road blocks in the area of interest. As an example, as illustrated in FIG. 1A, the road block 110 is associated with seven physical traffic lights 112a, 112b, 112c, 132a, 132b, 132c, 132e that regulate vehicles from the road block 110 entering the intersection 100. Among them, the physical traffic lights 112a, 112b, 112c are positioned at the road block 110, and the physical traffic lights 132a, 132b, 132c, 132e are positioned at the road block 130 facing the road block 110.

In some embodiments, the computing system determines the area of interest from a map based on at least one of a current location of a vehicle, a current route of a vehicle, or a particular region. In some examples, the computing system selects a region to determine traffic light behaviors in the region that includes one or more intersections. In some examples, a route of a vehicle includes one or more intersections. In some examples, there are one or more intersections around a vehicle based on a location of the vehicle. The computing system obtains area information of each intersection to determine determines traffic light behaviors of the intersection.

The information corresponding to the area of interest includes information of physical traffic lights in the area of interest, e.g., location, orientation, type, shape, color, or state. The information of physical traffic lights in the area of interest is consistent with each other. In some embodiments, the computing system obtains a current state of at least one physical traffic light of the plurality of physical traffic lights associated with a road block and determines current states of a remainder of the plurality of physical traffic lights associated with the road block based on the obtained current state of the least one physical traffic light.

With continued reference to the process 400, the computing system determines, for each road block, information of a logical traffic light representing a grouping of the plurality of physical traffic lights associated with the road block based on the information corresponding to the area of interest (404). The computing system can generate the logical traffic light for the road block and determine one or more characteristics of the logical traffic light based on the information corresponding to the area of interest. The information of the logical traffic light includes the one or more characteristics of the logical traffic light.

In some examples, as illustrated in FIG. 1B, the logical traffic light (e.g., the logical traffic light 152, 154, 156, 158 of FIG. 1B) includes a plurality of logical bulbs (e.g., red, yellow, green). The information of the logical traffic light includes information of each of the plurality of logical bulbs that includes at least one of shape, color, or state. The information of the logical traffic light can also include at least one of a number of states, a duration of each state, or a behavior. The behavior of the logical traffic light can include an interaction with one or more other logical traffic lights at the area of interest. Each of the plurality of logical bulbs corresponds to respective physical bulbs, among the plurality of physical traffic lights, that have a same shape, a same color, and a same state.

In some embodiments, the computing system stores information about logical traffic lights associated with the two or more road blocks at the area of interest in a database. The computing system can generate an identifier of the area of interest and associate the identifier of the area of interest with multiple states. Each of the multiple states is associated with a respective duration of the state (e.g., 5 seconds, 20 seconds, 30 seconds), identifiers of multiple road blocks in the area of interest, and information of a logical traffic light associated with each of the multiple road blocks in the state.

In some embodiments, the computing system uses a finite state machine (FSM) defined by the multiple states to determine a state of the area of interest. The computing system can determine the area of interest to be in a specific state of the multiple states at a specific instant in time. The computing system can transition the area of interest from a first state to a second state in a state transition loop formed by the multiple states at an end of a duration of the first state. The FSM maintains the area of interest in a consistent state. The computing system can, in conjunction with transitioning the area of interest from the first state to the second state, transition the logical traffic lights associated with the area of interest into states corresponding to the second state of the area of interest.

In some embodiments, the computing system further associates the identifier of the area of interest with one or more trigger events and transitions the area of interest into a corresponding specific state in response to an occurrence of each of the one or more trigger events. In some examples, a trigger event is associated with a distance between the vehicle and the area of interest. In some examples, a trigger event is associated with an expiration of a time period.

In some embodiments, the computing system generates representations of vehicles, configure the vehicles to approach and/or traverse the area of interest, and determine, based on a change of state of the logical traffic lights at the area of interest, behaviors of the vehicles as the vehicles are approaching and/or traversing the area of interest. The computing system can adjust a corresponding duration of at least one state of the multiple states based on a result of determining the behaviors of the vehicles.

With continued reference to the process 400, in some embodiments, the computing system configures one or more properties of at least one physical traffic light (e.g., in a virtual world or a real world) associated with the logical traffic light based on the determined information corresponding to the logical traffic light (406). The computing system can change one or more characteristics of at least one logical traffic light associated with the area of interest based on a change of a state of the area of interest, and change one or more properties of at least one physical traffic light corresponding to the at least one logical traffic light based on the change of the one or more characteristics of the at least one logical traffic light. For example, the computing system can change a duration of each state of the at least one physical traffic light, a location of the at least one physical traffic light, and/or a number of the at least one physical traffic light.

In some embodiments, the computing system provides data associated with the logical traffic lights that includes the one or more characteristics of the logical traffic lights for visualization using a graphical interface, e.g., on a display of the computing system.

### Example Systems and Applications

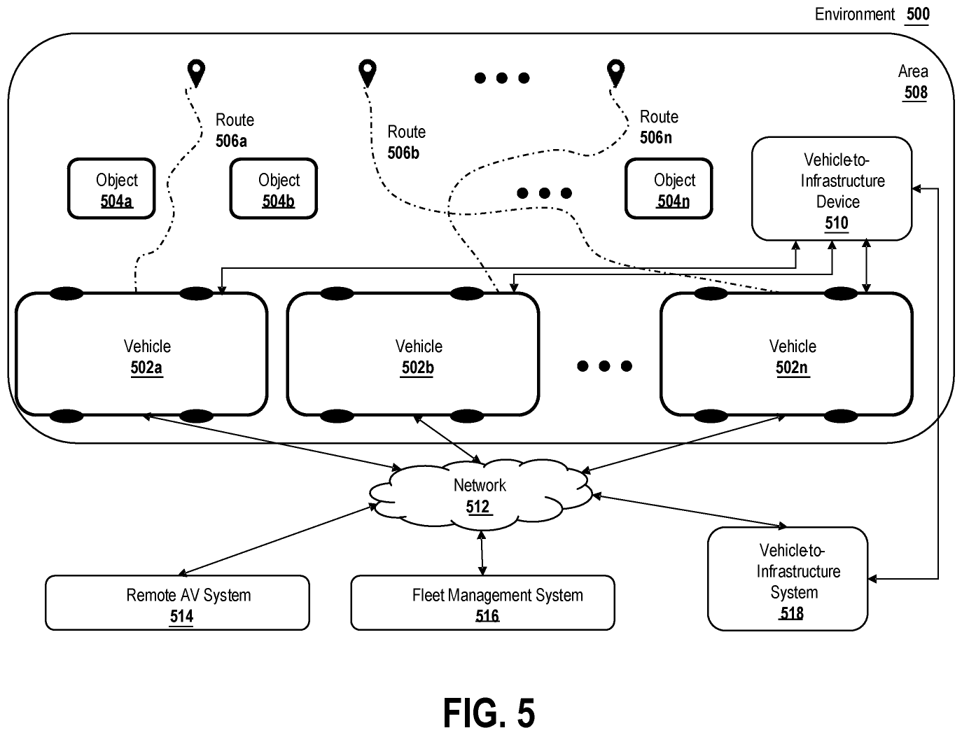

Implementations of the present disclosure provide techniques for managing traffic light behaviors using logical traffic lights at areas of interest, which can be applied in any suitable systems and/or any suitable applications. For illustration, the following descriptions with reference to FIGS. 5 to 10 disclose implementations of the techniques in vehicles, e.g., autonomous vehicles.

Referring now to FIG. 5, illustrated is example environment 500 in which vehicles that include autonomous systems, as well as vehicles that do not, are operated. As illustrated, environment 500 includes vehicles 502a-502n, objects 504a-504n, routes 506a-506n, area 508, vehicle-to-infrastructure (V2I) device 510, network 512, remote autonomous vehicle (AV) system 514, fleet management system 516, and V2I system 518. Vehicles 502a-502n, vehicle-to-infrastructure (V2I) device 510, network 512, autonomous vehicle (AV) system 514, fleet management system 516, and V2I system 518 interconnect (e.g., establish a connection to communicate and/or the like) via wired connections, wireless connections, or a combination of wired or wireless connections. In some embodiments, objects 504a-504n interconnect with at least one of vehicles 502a-502n, vehicle-to-infrastructure (V2I) device 510, network 512, autonomous vehicle (AV) system 514, fleet management system 516, and V2I system 518 via wired connections, wireless connections, or a combination of wired or wireless connections.

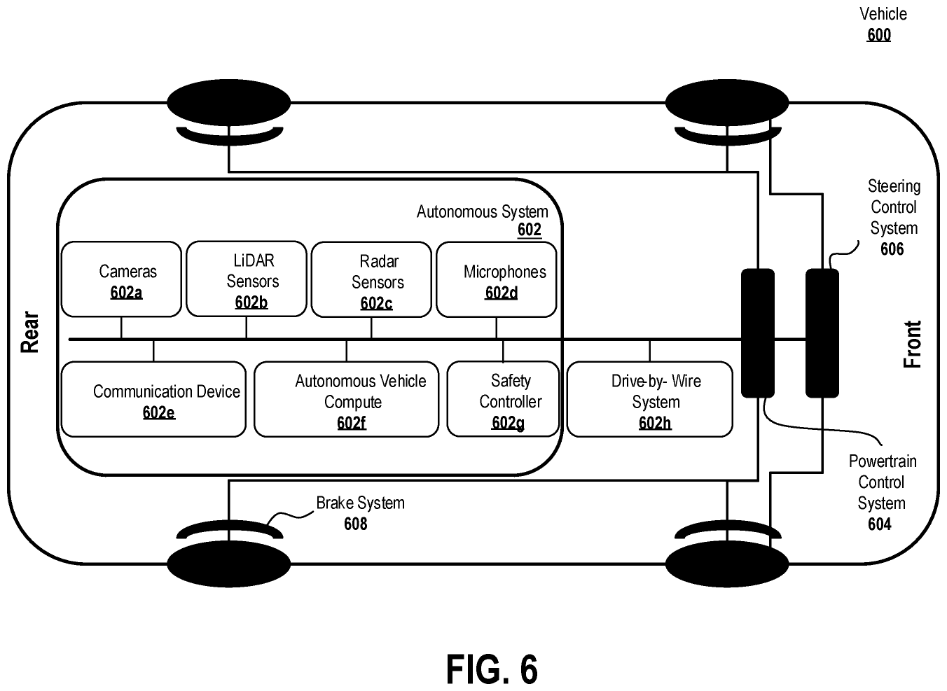

Vehicles 502a-502n (referred to individually as vehicle 502 and collectively as vehicles 502) include at least one device configured to transport goods and/or people. In some embodiments, vehicles 502 are configured to be in communication with V2I device 510, remote AV system 514, fleet management system 516, and/or V2I system 518 via network 512. In some embodiments, vehicles 502 include cars, buses, trucks, trains, and/or the like. In some embodiments, vehicles 502 are the same as, or similar to, vehicles 600, described herein (see FIG. 6). In some embodiments, a vehicle 600 of a set of vehicles 600 is associated with an autonomous fleet manager. In some embodiments, vehicles 502 travel along respective routes 506a-506n (referred to individually as route 506 and collectively as routes 506), as described herein. In some embodiments, one or more vehicles 502 include an autonomous system (e.g., an autonomous system that is the same as or similar to autonomous system 602).

Objects 504a-504n (referred to individually as object 504 and collectively as objects 504) include, for example, at least one vehicle, at least one pedestrian, at least one cyclist, at least one structure (e.g., a building, a sign, a fire hydrant, etc.), and/or the like. Each object 504 is stationary (e.g., located at a fixed location for a period of time) or mobile (e.g., having a velocity and associated with at least one trajectory). In some embodiments, objects 504 are associated with corresponding locations in area 508.

Routes 506a-506n (referred to individually as route 506 and collectively as routes 506) are each associated with (e.g., prescribe) a sequence of actions (also known as a trajectory) connecting states along which an AV can navigate. Each route 506 starts at an initial state (e.g., a state that corresponds to a first spatiotemporal location, velocity, and/or the like) and a final goal state (e.g., a state that corresponds to a second spatiotemporal location that is different from the first spatiotemporal location) or goal region (e.g. a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 506 include a plurality of acceptable state sequences (e.g., a plurality of spatiotemporal location sequences), the plurality of state sequences associated with (e.g., defining) a plurality of trajectories. In an example, routes 506 include only high level actions or imprecise state locations, such as a series of connected roads dictating turning directions at roadway intersections. Additionally, or alternatively, routes 506 may include more precise actions or states such as, for example, specific target lanes or precise locations within the lane areas and targeted speed at those positions. In an example, routes 506 include a plurality of precise state sequences along the at least one high level action sequence with a limited lookahead horizon to reach intermediate goals, where the combination of successive iterations of limited horizon state sequences cumulatively correspond to a plurality of trajectories that collectively form the high level route to terminate at the final goal state or region.

Area 508 includes a physical area (e.g., a geographic region) within which vehicles 502 can navigate. In an example, area 508 includes at least one state (e.g., a country, a province, an individual state of a plurality of states included in a country, etc.), at least one portion of a state, at least one city, at least one portion of a city, etc. In some embodiments, area 508 includes at least one named thoroughfare (referred to herein as a “road”) such as a highway, an interstate highway, a parkway, a city street, etc. Additionally, or alternatively, in some examples area 508 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 502). In an example, a road includes at least one lane associated with (e.g., identified based on) at least one lane marking.

Vehicle-to-Infrastructure (V2I) device 510 (sometimes referred to as a Vehicle-to-Infrastructure (V2X) device) includes at least one device configured to be in communication with vehicles 502 and/or V2I infrastructure system 518. In some embodiments, V2I device 510 is configured to be in communication with vehicles 502, remote AV system 514, fleet management system 516, and/or V2I system 518 via network 512. In some embodiments, V2I device 510 includes a radio frequency identification (RFID) device, signage, cameras (e.g., two-dimensional (2D) and/or three-dimensional (3D) cameras), lane markers, streetlights, parking meters, etc. In some embodiments, V2I device 510 is configured to communicate directly with vehicles 502. Additionally, or alternatively, in some embodiments V2I device 510 is configured to communicate with vehicles 502, remote AV system 514, and/or fleet management system 516 via V2I system 518. In some embodiments, V2I device 510 is configured to communicate with V2I system 518 via network 512.

Network 512 includes one or more wired and/or wireless networks. In an example, network 512 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 514 includes at least one device configured to be in communication with vehicles 502, V2I device 510, network 512, remote AV system 514, fleet management system 516, and/or V2I system 518 via network 512. In an example, remote AV system 514 includes a server, a group of servers, and/or other like devices. In some embodiments, remote AV system 514 is co-located with the fleet management system 516. In some embodiments, remote AV system 514 is involved in the installation of some or all of the components of a vehicle, including an autonomous system, an autonomous vehicle compute, software implemented by an autonomous vehicle compute, and/or the like. In some embodiments, remote AV system 514 maintains (e.g., updates and/or replaces) such components and/or software during the lifetime of the vehicle.

Fleet management system 516 includes at least one device configured to be in communication with vehicles 502, V2I device 510, remote AV system 514, and/or V2I infrastructure system 518. In an example, fleet management system 516 includes a server, a group of servers, and/or other like devices. In some embodiments, fleet management system 516 is associated with a ridesharing company (e.g., an organization that controls operation of multiple vehicles (e.g., vehicles that include autonomous systems and/or vehicles that do not include autonomous systems) and/or the like).

In some embodiments, V2I system 518 includes at least one device configured to be in communication with vehicles 502, V2I device 510, remote AV system 514, and/or fleet management system 516 via network 512. In some examples, V2I system 518 is configured to be in communication with V2I device 510 via a connection different from network 512. In some embodiments, V2I system 518 includes a server, a group of servers, and/or other like devices. In some embodiments, V2I system 518 is associated with a municipality or a private institution (e.g., a private institution that maintains V2I device 510 and/or the like).

The number and arrangement of elements illustrated in FIG. 5 are provided as an example. There can be additional elements, fewer elements, different elements, and/or differently arranged elements, than those illustrated in FIG. 5. Additionally, or alternatively, at least one element of environment 500 can perform one or more functions described as being performed by at least one different element of FIG. 5. Additionally, or alternatively, at least one set of elements of environment 500 can perform one or more functions described as being performed by at least one different set of elements of environment 500.

Referring now to FIG. 6, vehicle 600 includes autonomous system 602, powertrain control system 604, steering control system 606, and brake system 608. In some embodiments, vehicle 600 is the same as or similar to vehicle 502 (see FIG. 5). In some embodiments, vehicle 502 have autonomous capability (e.g., implement at least one function, feature, device, and/or the like that enable vehicle 600 to be partially or fully operated without human intervention including, without limitation, fully autonomous vehicles (e.g., vehicles that forego reliance on human intervention), highly autonomous vehicles (e.g., vehicles that forego reliance on human intervention in certain situations), and/or the like). For a detailed description of fully autonomous vehicles and highly autonomous vehicles, reference may be made to SAE International's standard J3016: Taxonomy and Definitions for Terms Related to On-Road Motor Vehicle Automated Driving Systems, which is incorporated by reference in its entirety. In some embodiments, vehicle 600 is associated with an autonomous fleet manager and/or a ridesharing company.

Autonomous system 602 includes a sensor suite that includes one or more devices such as cameras 602a, LiDAR sensors 602b, radar sensors 602c, and microphones 602d. In some embodiments, autonomous system 602 can include more or fewer devices and/or different devices (e.g., ultrasonic sensors, inertial sensors, GPS receivers (discussed below), odometry sensors that generate data associated with an indication of a distance that vehicle 600 has traveled, and/or the like). In some embodiments, autonomous system 602 uses the one or more devices included in autonomous system 602 to generate data associated with environment 500, described herein. The data generated by the one or more devices of autonomous system 602 can be used by one or more systems described herein to observe the environment (e.g., environment 500) in which vehicle 600 is located. In some embodiments, autonomous system 602 includes communication device 602e, autonomous vehicle compute 602f, and drive-by-wire (DBW) system 602h.

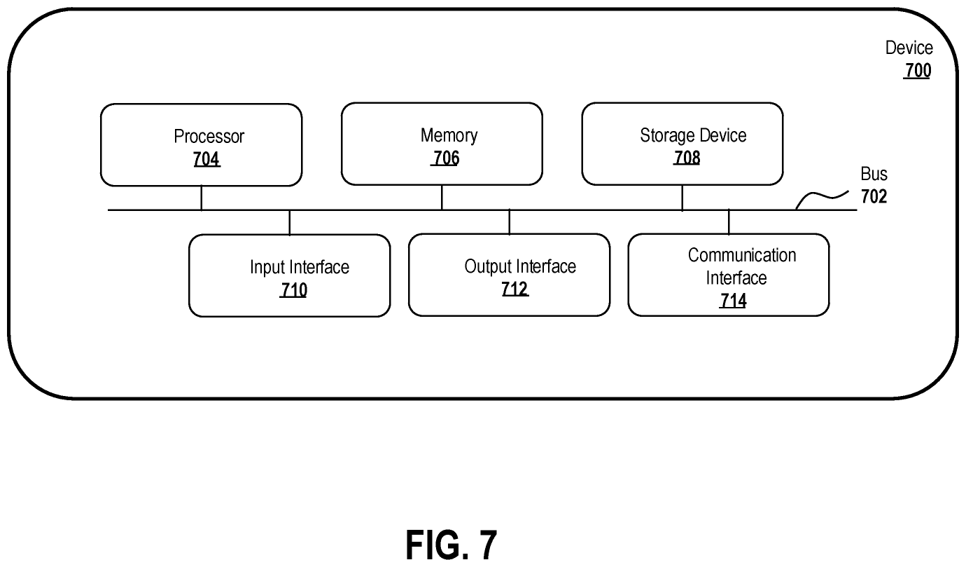

Cameras 602a include at least one device configured to be in communication with communication device 602e, autonomous vehicle compute 602f, and/or safety controller 602g via a bus (e.g., a bus that is the same as or similar to bus 702 of FIG. 7). Cameras 602a include at least one camera (e.g., a digital camera using a light sensor such as a charge-coupled device (CCD), a thermal camera, an infrared (IR) camera, an event camera, and/or the like) to capture images including physical objects (e.g., cars, buses, curbs, people, and/or the like). In some embodiments, camera 602a generates camera data as output. In some examples, camera 602a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 602a includes a plurality of independent cameras configured on (e.g., positioned on) a vehicle to capture images for the purpose of stereopsis (stereo vision). In some examples, camera 602a includes a plurality of cameras that generate image data and transmit the image data to autonomous vehicle compute 602f and/or a fleet management system (e.g., a fleet management system that is the same as or similar to fleet management system 516 of FIG. 5). In such an example, autonomous vehicle compute 602f determines depth to one or more objects in a field of view of at least two cameras of the plurality of cameras based on the image data from the at least two cameras. In some embodiments, cameras 602a is configured to capture images of objects within a distance from cameras 602a (e.g., up to 100 meters, up to a kilometer, and/or the like). Accordingly, cameras 602a include features such as sensors and lenses that are optimized for perceiving objects that are at one or more distances from cameras 602a.

In an embodiment, camera 602a includes at least one camera configured to capture one or more images associated with one or more traffic lights, street signs and/or other physical objects that provide visual navigation information. In some embodiments, camera 602a generates traffic light detection (TLD) data (or traffic light data) associated with one or more images. In some examples, camera 602a generates TLD data associated with one or more images that include a format (e.g., RAW, JPEG, PNG, and/or the like). In some embodiments, camera 602a that generates TLD data differs from other systems described herein incorporating cameras in that camera 602a can include one or more cameras with a wide field of view (e.g., a wide-angle lens, a fish-eye lens, a lens having a viewing angle of approximately 120 degrees or more, and/or the like) to generate images about as many physical objects as possible.

Laser Detection and Ranging (LiDAR) sensors 602b include at least one device configured to be in communication with communication device 602e, autonomous vehicle compute 602f, and/or safety controller 602g via a bus (e.g., a bus that is the same as or similar to bus 702 of FIG. 7). LiDAR sensors 602b include a system configured to transmit light from a light emitter (e.g., a laser transmitter). Light emitted by LiDAR sensors 602b include light (e.g., infrared light and/or the like) that is outside of the visible spectrum. In some embodiments, during operation, light emitted by LiDAR sensors 602b encounters a physical object (e.g., a vehicle) and is reflected back to LiDAR sensors 602b. In some embodiments, the light emitted by LiDAR sensors 602b does not penetrate the physical objects that the light encounters. LiDAR sensors 602b also include at least one light detector which detects the light that was emitted from the light emitter after the light encounters a physical object. In some embodiments, at least one data processing system associated with LiDAR sensors 602b generates an image (e.g., a point cloud, a combined point cloud, and/or the like) representing the objects included in a field of view of LiDAR sensors 602b. In some examples, the at least one data processing system associated with LiDAR sensor 602b generates an image that represents the boundaries of a physical object, the surfaces (e.g., the topology of the surfaces) of the physical object, and/or the like. In such an example, the image is used to determine the boundaries of physical objects in the field of view of LiDAR sensors 602b.

Radio Detection and Ranging (radar) sensors 602c include at least one device configured to be in communication with communication device 602e, autonomous vehicle compute 602f, and/or safety controller 602g via a bus (e.g., a bus that is the same as or similar to bus 702 of FIG. 7). Radar sensors 602c include a system configured to transmit radio waves (either pulsed or continuously). The radio waves transmitted by radar sensors 602c include radio waves that are within a predetermined spectrum. In some embodiments, during operation, radio waves transmitted by radar sensors 602c encounter a physical object and are reflected back to radar sensors 602c. In some embodiments, the radio waves transmitted by radar sensors 602c are not reflected by some objects. In some embodiments, at least one data processing system associated with radar sensors 602c generates signals representing the objects included in a field of view of radar sensors 602c. For example, the at least one data processing system associated with radar sensor 602c generates an image that represents the boundaries of a physical object, the surfaces (e.g., the topology of the surfaces) of the physical object, and/or the like. In some examples, the image is used to determine the boundaries of physical objects in the field of view of radar sensors 602c.

Microphones 602d includes at least one device configured to be in communication with communication device 602e, autonomous vehicle compute 602f, and/or safety controller 602g via a bus (e.g., a bus that is the same as or similar to bus 702 of FIG. 7). Microphones 602d include one or more microphones (e.g., array microphones, external microphones, and/or the like) that capture audio signals and generate data associated with (e.g., representing) the audio signals. In some examples, microphones 602d include transducer devices and/or like devices. In some embodiments, one or more systems described herein can receive the data generated by microphones 602d and determine a position of an object relative to vehicle 600 (e.g., a distance and/or the like) based on the audio signals associated with the data.

Communication device 602e include at least one device configured to be in communication with cameras 602a, LiDAR sensors 602b, radar sensors 602c, microphones 602d, autonomous vehicle compute 602f, safety controller 602g, and/or DBW system 602h. For example, communication device 602e may include a device that is the same as or similar to communication interface 714 of FIG. 7. In some embodiments, communication device 602e includes a vehicle-to-vehicle (V2V) communication device (e.g., a device that enables wireless communication of data between vehicles).

Autonomous vehicle compute 602f include at least one device configured to be in communication with cameras 602a, LiDAR sensors 602b, radar sensors 602c, microphones 602d, communication device 602e, safety controller 602g, and/or DBW system 602h. In some examples, autonomous vehicle compute 602f includes a device such as a client device, a mobile device (e.g., a cellular telephone, a tablet, and/or the like) a server (e.g., a computing device including one or more central processing units, graphical processing units, and/or the like), and/or the like. In some embodiments, autonomous vehicle compute 602f is the same as or similar to autonomous vehicle compute 800, described herein. Additionally, or alternatively, in some embodiments autonomous vehicle compute 602f is configured to be in communication with an autonomous vehicle system (e.g., an autonomous vehicle system that is the same as or similar to remote AV system 514 of FIG. 5), a fleet management system (e.g., a fleet management system that is the same as or similar to fleet management system 516 of FIG. 5), a V2I device (e.g., a V2I device that is the same as or similar to V2I device 510 of FIG. 5), and/or a V2I system (e.g., a V2I system that is the same as or similar to V2I system 518 of FIG. 5).

Safety controller 602g includes at least one device configured to be in communication with cameras 602a, LiDAR sensors 602b, radar sensors 602c, microphones 602d, communication device 602e, autonomous vehicle computer 602f, and/or DBW system 602h. In some examples, safety controller 602g includes one or more controllers (electrical controllers, electromechanical controllers, and/or the like) that are configured to generate and/or transmit control signals to operate one or more devices of vehicle 600 (e.g., powertrain control system 604, steering control system 606, brake system 608, and/or the like). In some embodiments, safety controller 602g is configured to generate control signals that take precedence over (e.g., overrides) control signals generated and/or transmitted by autonomous vehicle compute 602f.

DBW system 602h includes at least one device configured to be in communication with communication device 602e and/or autonomous vehicle compute 602f. In some examples, DBW system 602h includes one or more controllers (e.g., electrical controllers, electromechanical controllers, and/or the like) that are configured to generate and/or transmit control signals to operate one or more devices of vehicle 600 (e.g., powertrain control system 604, steering control system 606, brake system 608, and/or the like). Additionally, or alternatively, the one or more controllers of DBW system 602h are configured to generate and/or transmit control signals to operate at least one different device (e.g., a turn signal, headlights, door locks, windshield wipers, and/or the like) of vehicle 600.

Powertrain control system 604 includes at least one device configured to be in communication with DBW system 602h. In some examples, powertrain control system 604 includes at least one controller, actuator, and/or the like. In some embodiments, powertrain control system 604 receives control signals from DBW system 602h and powertrain control system 604 causes vehicle 600 to start moving forward, stop moving forward, start moving backward, stop moving backward, accelerate in a direction, decelerate in a direction, perform a left turn, perform a right turn, and/or the like. In an example, powertrain control system 604 causes the energy (e.g., fuel, electricity, and/or the like) provided to a motor of the vehicle to increase, remain the same, or decrease, causing at least one wheel of vehicle 600 to rotate or not rotate.

Steering control system 606 includes at least one device configured to rotate one or more wheels of vehicle 600. In some examples, steering control system 606 includes at least one controller, actuator, and/or the like. In some embodiments, steering control system 606 causes the front two wheels and/or the rear two wheels of vehicle 600 to rotate to the left or right to cause vehicle 600 to turn to the left or right.

Brake system 608 includes at least one device configured to actuate one or more brakes to cause vehicle 600 to reduce speed and/or remain stationary. In some examples, brake system 608 includes at least one controller and/or actuator that is configured to cause one or more calipers associated with one or more wheels of vehicle 600 to close on a corresponding rotor of vehicle 600. Additionally, or alternatively, in some examples brake system 608 includes an automatic emergency braking (AEB) system, a regenerative braking system, and/or the like.

In some embodiments, vehicle 600 includes at least one platform sensor (not explicitly illustrated) that measures or infers properties of a state or a condition of vehicle 600. In some examples, vehicle 600 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like.

Referring now to FIG. 7, illustrated is a schematic diagram of a device 700. As illustrated, device 700 includes processor 704, memory 706, storage component 708, input interface 710, output interface 712, communication interface 714, and bus 702. In some embodiments, device 700 corresponds to at least one device of vehicles 502 (e.g., at least one device of a system of vehicles 502), and/or one or more devices of network 512 (e.g., one or more devices of a system of network 512). In some embodiments, one or more devices of vehicles 502 (e.g., one or more devices of a system of vehicles 502), and/or one or more devices of network 512 (e.g., one or more devices of a system of network 512) include at least one device 700 and/or at least one component of device 700. As shown in FIG. 7, device 700 includes bus 702, processor 704, memory 706, storage component 708, input interface 710, output interface 712, and communication interface 714.

Bus 702 includes a component that permits communication among the components of device 700. In some embodiments, processor 704 is implemented in hardware, software, or a combination of hardware and software. In some examples, processor 704 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 706 includes random access memory (RAM), read-only memory (ROM), and/or another type of dynamic and/or static storage device (e.g., flash memory, magnetic memory, optical memory, and/or the like) that stores data and/or instructions for use by processor 304.

Storage component 708 stores data and/or software related to the operation and use of device 700. In some examples, storage component 708 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 710 includes a component that permits device 700 to receive information, such as via user input (e.g., a touchscreen display, a keyboard, a keypad, a mouse, a button, a switch, a microphone, a camera, and/or the like). Additionally or alternatively, in some embodiments input interface 710 includes a sensor that senses information (e.g., a global positioning system (GPS) receiver, an accelerometer, a gyroscope, an actuator, and/or the like). Output interface 712 includes a component that provides output information from device 700 (e.g., a display, a speaker, one or more light-emitting diodes (LEDs), and/or the like).

In some embodiments, communication interface 714 includes a transceiver-like component (e.g., a transceiver, a separate receiver and transmitter, and/or the like) that permits device 700 to communicate with other devices via a wired connection, a wireless connection, or a combination of wired and wireless connections. In some examples, communication interface 714 permits device 700 to receive information from another device and/or provide information to another device. In some examples, communication interface 714 includes an Ethernet interface, an optical interface, a coaxial interface, an infrared interface, a radio frequency (RF) interface, a universal serial bus (USB) interface, a Wi-Fi® interface, a cellular network interface, and/or the like.

In some embodiments, device 700 performs one or more processes described herein. Device 700 performs these processes based on processor 704 executing software instructions stored by a computer-readable medium, such as memory 705 and/or storage component 708. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 706 and/or storage component 708 from another computer-readable medium or from another device via communication interface 714. When executed, software instructions stored in memory 706 and/or storage component 708 cause processor 704 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 706 and/or storage component 708 includes data storage or at least one data structure (e.g., a database and/or the like). Device 700 is capable of receiving information from, storing information in, communicating information to, or searching information stored in the data storage or the at least one data structure in memory 706 or storage component 708. In some examples, the information includes network data, input data, output data, or any combination thereof.

In some embodiments, device 700 is configured to execute software instructions that are either stored in memory 706 and/or in the memory of another device (e.g., another device that is the same as or similar to device 700). As used herein, the term “module” refers to at least one instruction stored in memory 706 and/or in the memory of another device that, when executed by processor 704 and/or by a processor of another device (e.g., another device that is the same as or similar to device 700) cause device 700 (e.g., at least one component of device 700) to perform one or more processes described herein. In some embodiments, a module is implemented in software, firmware, hardware, and/or the like.

The number and arrangement of components illustrated in FIG. 7 are provided as an example. In some embodiments, device 700 can include additional components, fewer components, different components, or differently arranged components than those illustrated in FIG. 7. Additionally or alternatively, a set of components (e.g., one or more components) of device 700 can perform one or more functions described as being performed by another component or another set of components of device 700.

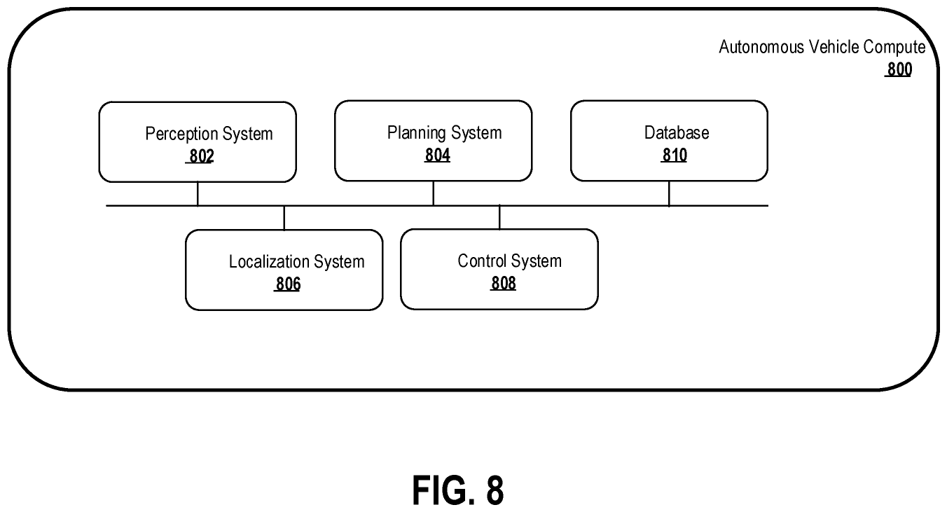

Referring now to FIG. 8, illustrated is an example block diagram of an autonomous vehicle compute 800 (sometimes referred to as an “AV stack”). As illustrated, autonomous vehicle compute 800 includes perception system 802 (sometimes referred to as a perception module), planning system 804 (sometimes referred to as a planning module), localization system 806 (sometimes referred to as a localization module), control system 808 (sometimes referred to as a control module), and database 810. In some embodiments, perception system 802, planning system 804, localization system 806, control system 808, and database 810 are included and/or implemented in an autonomous navigation system of a vehicle (e.g., autonomous vehicle compute 602f of vehicle 600). Additionally, or alternatively, in some embodiments, perception system 802, planning system 804, localization system 806, control system 808, and database 810 are included in one or more standalone systems (e.g., one or more systems that are the same as or similar to autonomous vehicle compute 800 and/or the like). In some examples, perception system 802, planning system 804, localization system 806, control system 808, and database 810 are included in one or more standalone systems that are located in a vehicle and/or at least one remote system as described herein. In some embodiments, any and/or all of the systems included in autonomous vehicle compute 800 are implemented in software (e.g., in software instructions stored in memory), computer hardware (e.g., by microprocessors, microcontrollers, application-specific integrated circuits [ASICs], Field Programmable Gate Arrays (FPGAs), and/or the like), or combinations of computer software and computer hardware. It will also be understood that, in some embodiments, autonomous vehicle compute 800 is configured to be in communication with a remote system (e.g., an autonomous vehicle system that is the same as or similar to remote AV system 514, a fleet management system 516 that is the same as or similar to fleet management system 516, a V2I system that is the same as or similar to V2I system 518, and/or the like).

In some embodiments, perception system 802 receives data associated with at least one physical object (e.g., data that is used by perception system 802 to detect the at least one physical object) in an environment and classifies the at least one physical object. In some examples, perception system 802 receives image data captured by at least one camera (e.g., cameras 602a), the image associated with (e.g., representing) one or more physical objects within a field of view of the at least one camera. In such an example, perception system 802 classifies at least one physical object based on one or more groupings of physical objects (e.g., bicycles, vehicles, traffic signs, pedestrians, and/or the like). In some embodiments, perception system 802 transmits data associated with the classification of the physical objects to planning system 804 based on perception system 802 classifying the physical objects.

In some embodiments, planning system 804 receives data associated with a destination and generates data associated with at least one route (e.g., routes 506) along which a vehicle (e.g., vehicles 502) can travel along toward a destination. In some embodiments, planning system 804 periodically or continuously receives data from perception system 802 (e.g., data associated with the classification of physical objects, described above) and planning system 804 updates the at least one trajectory or generates at least one different trajectory based on the data generated by perception system 802. In some embodiments, planning system 804 receives data associated with an updated position of a vehicle (e.g., vehicles 502) from localization system 806 and planning system 804 updates the at least one trajectory or generates at least one different trajectory based on the data generated by localization system 806.

In some embodiments, localization system 806 receives data associated with (e.g., representing) a location of a vehicle (e.g., vehicles 502) in an area. In some examples, localization system 806 receives LiDAR data associated with at least one point cloud generated by at least one LiDAR sensor (e.g., LiDAR sensors 602b). In certain examples, localization system 806 receives data associated with at least one point cloud from multiple LiDAR sensors and localization system 806 generates a combined point cloud based on each of the point clouds. In these examples, localization system 806 compares the at least one point cloud or the combined point cloud to two-dimensional (2D) and/or a three-dimensional (3D) map of the area stored in database 810. Localization system 806 then determines the position of the vehicle in the area based on localization system 806 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 806 receives Global Navigation Satellite System (GNSS) data generated by a global positioning system (GPS) receiver. In some examples, localization system 806 receives GNSS data associated with the location of the vehicle in the area and localization system 806 determines a latitude and longitude of the vehicle in the area. In such an example, localization system 806 determines the position of the vehicle in the area based on the latitude and longitude of the vehicle. In some embodiments, localization system 806 generates data associated with the position of the vehicle. In some examples, localization system 806 generates data associated with the position of the vehicle based on localization system 806 determining the position of the vehicle. In such an example, the data associated with the position of the vehicle includes data associated with one or more semantic properties corresponding to the position of the vehicle.

In some embodiments, control system 808 receives data associated with at least one trajectory from planning system 804 and control system 808 controls operation of the vehicle. In some examples, control system 808 receives data associated with at least one trajectory from planning system 804 and control system 808 controls operation of the vehicle by generating and transmitting control signals to cause a powertrain control system (e.g., DBW system 602h, powertrain control system 604, and/or the like), a steering control system (e.g., steering control system 606), and/or a brake system (e.g., brake system 608) to operate. In an example, where a trajectory includes a left turn, control system 808 transmits a control signal to cause steering control system 806 to adjust a steering angle of vehicle 600, causing vehicle 600 to turn left. Additionally, or alternatively, control system 808 generates and transmits control signals to cause other devices (e.g., headlights, turn signal, door locks, windshield wipers, and/or the like) of vehicle 600 to change states.

In some embodiments, perception system 802, planning system 804, localization system 806, and/or control system 808 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 802, planning system 804, localization system 806, and/or control system 808 implement at least one machine learning model alone or in combination with one or more of the above-noted systems. In some examples, perception system 802, planning system 804, localization system 806, and/or control system 808 implement at least one machine learning model as part of a pipeline (e.g., a pipeline for identifying one or more objects located in an environment and/or the like).

Database 810 stores data that is transmitted to, received from, and/or updated by perception system 802, planning system 804, localization system 806 and/or control system 808. In some examples, database 810 includes a storage component (e.g., a storage component that is the same as or similar to storage component 708 of FIG. 7) that stores data and/or software related to the operation and uses at least one system of autonomous vehicle compute 800. In some embodiments, database 810 stores data associated with 2D and/or 3D maps of at least one area. In some examples, database 810 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 502 and/or vehicle 600) can drive along one or more drivable regions (e.g., single-lane roads, multi-lane roads, highways, back roads, off road trails, and/or the like) and cause at least one LiDAR sensor (e.g., a LiDAR sensor that is the same as or similar to LiDAR sensors 602b) to generate data associated with an image representing the objects included in a field of view of the at least one LiDAR sensor.

In some embodiments, database 810 can be implemented across a plurality of devices. In some examples, database 810 is included in a vehicle (e.g., a vehicle that is the same as or similar to vehicles 502 and/or vehicle 600), an autonomous vehicle system (e.g., an autonomous vehicle system that is the same as or similar to remote AV system 514, a fleet management system (e.g., a fleet management system that is the same as or similar to fleet management system 516 of FIG. 5, a V2I system (e.g., a V2I system that is the same as or similar to V2I system 518 of FIG. 5) and/or the like.

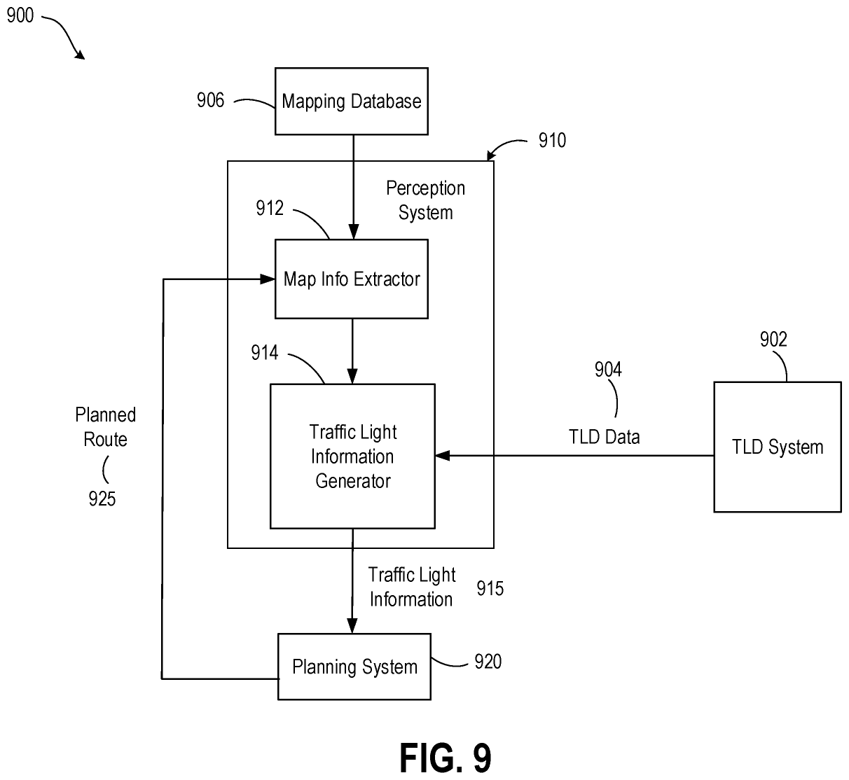

FIG. 9 shows a block diagram of an architecture 900 for managing behaviors of traffic lights, in accordance with one or more embodiments. In an embodiment, the architecture 900 is implemented in an autonomous system of a vehicle. In some examples, the vehicle is an embodiment of the vehicle 600 shown in FIG. 6, and the architecture 900 is implemented by the autonomous system 602 of the vehicle 600. The architecture 900 is configured to manage traffic light behaviors at areas of interest (e.g., intersections) in a consistent and robust way for reliable and efficient decision making by using logical traffic lights to represent physical traffic lights at the areas of interest.

The architecture 900 includes a perception system 910 (which can be, e.g., the perception system 802 shown in FIG. 8, in some embodiments) and a planning system 920 (which can be, e.g., the planning system 808 shown in FIG. 8, in some embodiments). The perception system 910 selectively obtains area information of at least one area of interest (e.g., an intersection) from a mapping database 906, e.g., based on a current location of the vehicle and/or a route of the vehicle. The mapping database 906 stores a data structure associating each area of interest with logical traffic light groupings of physical traffic lights at the area of interest and corresponding states determined by combinations of states of the logical traffic light groupings. Based on the area information and the route of the vehicle, the perception system 910 determines traffic light information 915, e.g., a state of the area of interest or a state of a logical traffic light for an incoming road block at the area of interest. The perception system 910 provides the traffic light information 915 to the planning system 920 to determine an action to be taken by the vehicle as it arrives at the area of interest. The action to be taken can be, for example, to stop, to slow down, or to continue at current speed, among other suitable actions. The planning system 920 determines the action based on the traffic light information 915 and other data, e.g., data from the localization system 806 and the database 810 of FIG. 8. The vehicle is operated in accordance with the determined action by a control system, e.g., the control system 808 as shown in FIG. 8.

In one embodiment, the architecture 900 includes the mapping database 906, e.g., implemented in the database 810 shown in FIG. 8. In another embodiment, the mapping databased 906 is external to the architecture 900 and stored in a server, e.g., the remote AV system 514 shown in FIG. 5. The mapping database 906 includes road network information, e.g., high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations of them), and maps describing the spatial locations of areas of interest such as intersections, crosswalks, traffic signs or other travel signals of various types. In an embodiment, the high-precision maps are constructed by adding data, through automatic or manual annotation, to low-precision maps. For illustration purposes only, an intersection is described herein as an example of an area of interest.

The mapping database 906 includes area information of intersections in maps. As discussed in further detail below, in one embodiment, area information of an intersection includes an intersection identifier (ID), a series of states for the intersection representing behaviors of traffic lights at the intersection, information about road blocks at the intersection, and information about logical traffic lights for the road blocks. In one embodiment, the mapping database 906 also stores information about physical traffic lights at the intersection.

The perception system 910 includes a map information extractor 912. The map information extractor 912 extracts area information of one or more areas of interest for the vehicle. Area information of an intersection includes intersection identifier (ID), a series of states for the intersection representing traffic light behaviors at the intersection, information of road blocks in the intersection, and information of logical traffic lights for the road blocks. The area information can be stored in a data structure as illustrated above.

In one example, based on a current location of the vehicle, the map information extractor 912 extracts area information of one or more intersections around the current location of the vehicle. In one example, based on a current route of the vehicle, the map information extractor 912 extracts area information of one or more intersections along the current route of the vehicle.

In one embodiment, the perception system 910 includes a traffic light information (TLI) generator 914. The TLI generator 914 is configured to generate traffic light information associated with the current route of the vehicle using the area information of the one or more intersections and the current route of the vehicle. For example, if the vehicle is travelling approaching an incoming road block (e.g., the road block 110 shown in FIG. 1A) at an intersection (e.g., the intersection 100 shown in FIG. 1A), the TLI generator 914 can determine which is a current state of the intersection and what is the remaining time for the current state, e.g., based on a simulation of traffic light behaviors of the intersection and/or one or more trigger events, a driving speed of the vehicle, a current location of the vehicle, and/or a distance between the vehicle and a center of the intersection.

In an embodiment, the TLI generator 914 determines what is a current state of the incoming road block and what is the remaining time for the current state, e.g., based on a simulation of traffic light behavior of the logical traffic light for the incoming road block and/or one or more trigger events, a driving speed of the vehicle, a current location of the vehicle, and/or a distance between the vehicle and a center of the intersection. The TLI generator 914 can filter out other road blocks at the intersection and use traffic light data of the incoming road block for the simulation and/or the determination.

In one embodiment, as shown in FIG. 9, the architecture 900 includes a traffic light detection (TLD) system 902 (e.g., the cameras 602a shown in FIG. 6) for sensing or measuring properties of the vehicle's environment. The TLD system 902 uses one or more cameras to obtain information about traffic lights, street signs, and other physical objects that provide visual navigation information. The TLD system 902 produces TLD data 904. TLD data can take the form of image data (e.g., data in an image data format such as RAW, JPEG, PNG, etc.). The TLD system 902 uses a camera with a wide field of view (e.g., using a wide-angle lens or a fish-eye lens) in order to obtain information about as many physical objects providing visual navigation information as possible, so that the vehicle has access to all relevant navigation information provided by these objects. For example, the viewing angle of the TLD system is about 120 degrees or more.

In some embodiments, the perception system 910 includes a traffic light information (TLI) generator 914 that receives the TLD data 904 from the TLD system 902. The TLI generator 914 can update the traffic light information 915 based on the TLD data 904. In some examples, the TLI generator 914 analyzes the TLD data 904 to determine actual information of physical traffic lights associated with a roadblock (e.g., the seven physical traffic lights for the road block 110 of FIG. 1A) to check/calibrate the traffic light information 915 (e.g., a current state of the logical traffic light 152 of FIG. 1B). If the traffic light information 915 does not match with the actual information of physical traffic lights, the TLI generator 914 updates the traffic light information based on the TLD data 904, e.g., by updating a state of the logical traffic light for the road block and a state of the intersection.

The perception system 910 provides the traffic light information 915 to the planning system 920. In some embodiments, the planning system 920 updates the route based on the traffic light information 915 and provides a planned route 925 to the perception system 910, e.g., the map information extractor 912. The perception system 910 can update area information of one or more intersections obtained from the mapping database 906 based on the planned route from the planning system 920.

Based on the traffic light information 915, the planning system 920 determines an action to be taken by the vehicle as it arrives the intersection, e.g., to stop, to slow down, or to continue at current speed, etc. The planning system 920 determines the action based on the traffic light information 915 and other data, e.g., data from the localization system 806 and the database 810 of FIG. 8. The vehicle is operated in accordance with the action by a control system, e.g., the control system 808 as shown in FIG. 8.

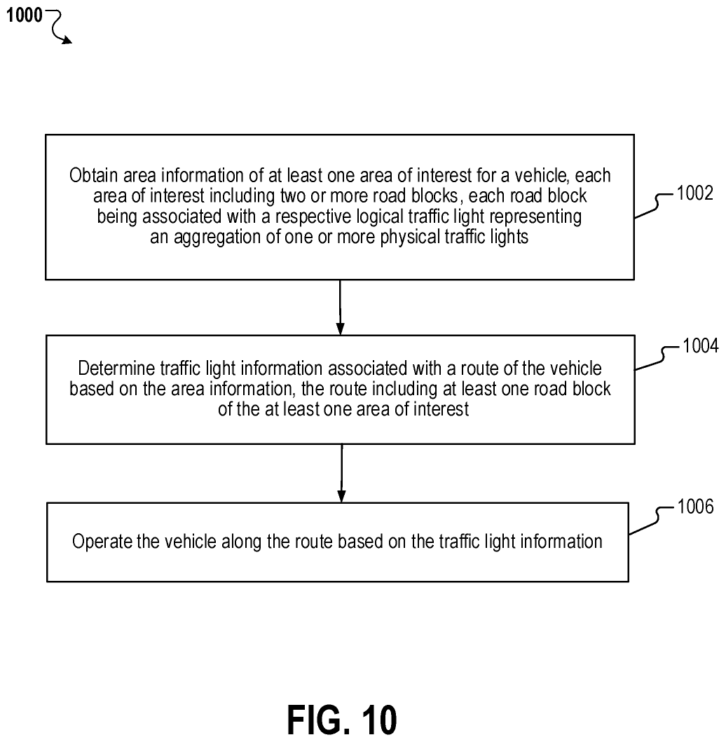

FIG. 10 illustrates a flowchart of a process 1000 for managing traffic light behaviors for vehicles, particularly for managing traffic light behaviors using information of logical traffic lights for road blocks at areas of interest. In some embodiments, the process 1000 is performed (e.g., completely, partially, and/or the like) by an autonomous system, e.g., vehicle 600 as shown in FIG. 6. Additionally, or alternatively, in some embodiments, the process 1000 is performed (e.g., completely, partially, and/or the like) by another device or group of devices separate from the autonomous system, e.g., the remote AV system 514 as shown in FIG. 5.

In some embodiments, the autonomous system includes a perception system, e.g., the perception system 802 as shown in FIG. 8 or the perception system 510 as shown in FIG. 5, a planning system, e.g., the planning system 804 as shown in FIG. 4 or the planning system 520 as shown in FIG. 5, and a control system, e.g., the control system 808 as shown in FIG. 8.

With reference to the process 1000, the autonomous system obtains area information of at least one area of interest for a vehicle (1002). The at least one area of interest includes two or more road blocks. The area information includes information about logical traffic lights associated with the road blocks in the at least one area of interest.

In some examples, a road block (e.g., the road block 110 of FIG. 1A) is associated with a first road (e.g., the road 114 of FIG. 1A) with a first road direction (e.g., the road direction 113 of FIG. 1A) and a second road (e.g., the road 116 of FIG. 1A) with a second road direction (e.g., the road direction 115 of FIG. 1A) different from the first road direction.

Each road block is associated with a respective logical traffic light representing an aggregation of one or more corresponding physical traffic lights controlling vehicular movement at the road block. In one example, as illustrated in FIG. 1A, the road block 110 is associated with seven physical traffic lights 112a, 112b, 112c, 132a, 132b, 132c, 132e that regulate vehicles from the road block 110 entering the intersection 100. The one or more physical traffic lights are represented by the respective logical traffic light, e.g., the logical traffic light 152 as shown in FIG. 1B.

In some embodiments, the vehicle is in motion. The autonomous system further determines that the vehicle is approaching an area of interest in a route traversed by the vehicle, and obtains the area information of the at least one area of interest in response to determining that the vehicle is approaching to the area of interest in the route traversed by the vehicle. In some examples, the at least one area of interest includes a plurality of areas of interest, including the approaching area of interest in the route traversed by the vehicle, and one or more other areas of interest adjacent to the approaching area of interest or in the route traversed by the vehicle.

The autonomous system obtains the area information of the at least one area of interest from a mapping database, e.g., the mapping database 906 of FIG. 9. In some embodiments, the autonomous system filters a plurality of areas of interest in the mapping database to determine the at least one area of interest for the vehicle based on a current location of the vehicle or the route of the vehicle. As an example, the at least one area of interest is adjacent to the current location and/or on the incoming route towards a destination.

In some embodiments, the autonomous system queries the mapping database to obtain a list of filtered logical traffic lights for the at least one area of interest based on the current location of the vehicle or the route of the vehicle. Each filtered logical traffic light has a true value for a boolean field.

In some embodiments, information of each of the logical traffic lights is obtained based on information of a plurality of corresponding physical traffic lights each configured to control (e.g., regulate or govern) traffic (e.g., vehicles or pedestrians coming from or going towards) of a respective road block associated with the logical traffic light. In some examples, each of the logical traffic lights includes a plurality of logical bulbs (e.g., red, yellow, green), and the information of each of the logical traffic lights includes information of each of the plurality of logical bulbs that includes at least one of shape (e.g., circle, right arrow, left arrow, up arrow, down arrow, unknown), color (e.g., red, yellow, green, unknown), or state (e.g., on, off, flashing, unknown). In some examples, each of the plurality of logical bulbs corresponds to respective physical bulbs, among the plurality of corresponding physical traffic lights, that have a same shape, a same color, and a same state.

In some embodiments, the area information of the at least one area of interest includes at least one of an identifier of the area of interest, an identifier of each of the road blocks in the area of interest, or a list of logical traffic lights. The area information does not include a list of physical traffic lights. In the area information, the identifier of the at least one area of interest is associated with multiple states (e.g., a finite number of states). Each of the multiple states is associated with a respective duration of the state (e.g., 20 seconds, 10 seconds, or 5 seconds), identifiers of multiple road blocks (e.g., incoming road block, outgoing road block, and/or adjacent road blocks), and information about a logical traffic light associated with each of the multiple road blocks in the state.

In some embodiments, the autonomous system uses a finite state machine (FSM) defined by the multiple states to determine a state of the area of interest. The autonomous system determines the at least one area of interest to be in a specific state of the multiple states at a specific instant in time, and transitions the area of interest from a first state to a second state in a state loop formed by the multiple states at an end of a duration of the first state. The FSM maintains the area of interest in a consistent state. Thus, the autonomous system transitions the logical traffic lights associated with the area of interest into states corresponding to the second state of the area of interest, together with the area of interest transitioning from the first state to the second state.

In some embodiments, in the area information, the identifier of the at least one area of interest is associated with one or more trigger events. The autonomous system transitions the at least one area of interest into a corresponding specific state in response to an occurrence of each of one or more trigger events. In some examples, a trigger event is associated with a distance between the vehicle and the area of interest. In some examples, a trigger event is associated with an expiration of a time period.

With continued reference to the process 1000, the autonomous system determines traffic light information associated with a route of the vehicle using the area information of the at least one area of interest (1004). The route includes at least one road block of the at least one area of interest.

In some examples, the traffic light information includes at least one of: a current state of the at least one area of interest including the at least one road block in the route and a remaining time for the current state of the at least one area of interest, or a current state of a logical traffic light associated with the at least one road block in the at least one area of interest included in the route, and a remaining time for the current state of the logical traffic light.

In some embodiments, the autonomous system determines the traffic light information associated with the route of the vehicle by simulating the area information of the at least one area of interest at a current time point, e.g., based on historical data or other real time data.

In some embodiments, the autonomous system obtains traffic light detection (TLD) data from a traffic light detection system of the vehicle (e.g., the cameras 602a as shown in FIG. 6). The autonomous system analyzes the TLD data to determine information of the physical traffic lights associated with the road block and to check or calibrate information of a logical traffic light corresponding to the physical traffic lights or a state of the area of interest. The autonomous system updates the traffic light information based on the TLD data.

In some embodiments, the autonomous system provides data associated with a graphical interface for visualization, e.g., to a visualizer, based on at least one of the area information or the traffic light information. The graphical interface can be an interface for a map. The graphical interface can display logical traffic lights with associated current states, e.g., as illustrated in FIGS. 2A to 2C.

With continued reference to the process 1000, the autonomous system operates the vehicle along the route using the traffic light information (1006). Based on the traffic light information, the autonomous system determines an action to be taken by the vehicle as it arrives the intersection, e.g., to stop, to slow down, or to continue at current speed, etc. The autonomous system determines the action based on the traffic light information and other data, e.g., data from the localization system 806 and the database 810 of FIG. 8. The vehicle is operated in accordance with the action by a control system, e.g., the control system 808 as shown in FIG. 8.

In some embodiments, the autonomous system updates the route based on the traffic light information and updates area information of one or more intersections obtained from the mapping database based on the planned route.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms recited in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

1. A method comprising:
obtaining, using at least one processor, information corresponding to an area of interest comprising two or more road blocks, wherein each road block is associated with a plurality of physical traffic lights configured to control traffic movements associated with the road block;
for each of the two or more road blocks, generating, using the at least one processor, a logical traffic light that represents a grouping of the plurality of physical traffic lights; and
determining, using the at least one processor, one or more characteristics of each logical traffic light based on the information corresponding to the area of interest.

2. The method of claim 1, further comprising:
obtaining a current state of at least one physical traffic light of the plurality of physical traffic lights; and
determining current states of a remainder of the plurality of physical traffic lights associated with the logical traffic light based on the obtained current state of the least one physical traffic light.

3. The method of claim 1, wherein the one or more characteristics of the logical traffic light comprise at least one of a number of states, a duration of each state, or a behavior of the logical traffic light that includes an interaction with one or more other logical traffic lights at the area of interest.

4. The method of claim 1, wherein the logical traffic light comprises a plurality of logical bulbs, and
wherein the one or more characteristics of the logical traffic light comprises one or more characteristics of each of the plurality of logical bulbs that includes at least one of shape, color, or state.

5. The method of claim 4, wherein each of the plurality of logical bulbs corresponds to respective physical bulbs, among the plurality of physical traffic lights, that have a same shape, a same color, and a same state.

6. The method of claim 1, wherein the information corresponding to the area of interest comprises information of physical traffic lights in the area of interest that includes at least one of location, orientation, type, shape, color, or state.

7. The method of claim 1, further comprising:
storing information about the logical traffic lights associated with the two or more road blocks at the area of interest in a database, the information comprising the determined one or more characteristics of the logical traffic light.

8. The method of claim 1, further comprising:
generating an identifier of the area of interest, the identifier being associated with multiple states,
wherein each of the multiple states is associated with
a respective duration of the state,
identifiers of the two or more road blocks in the area of interest, and
information of a logical traffic light associated with each of the two or more road blocks in the state.

9. The method of claim 8, further comprising:
determining the area of interest to be in a specific state of the multiple states at a specific instant in time.

10. The method of claim 8, further comprising:
transitioning the area of interest from a first state to a second state in a state loop formed by the multiple states at an end of a known duration of the first state.

11. The method of claim 10, further comprising:
in conjunction with transitioning the area of interest from the first state to the second state, transitioning the logical traffic lights associated with the area of interest into states corresponding to the second state of the area of interest.

12. The method of claim 8, further comprising:
associating the identifier of the area of interest with one or more trigger events; and
transitioning the area of interest into a corresponding specific state in response to an occurrence of a trigger event of the one or more trigger events.

13. The method of claim 8, further comprising:
generating, using the at least one processor, representations of vehicles;
configuring, using the at least one processor, the vehicles to approach and traverse the area of interest; and
determining, using the at least one processor and based on a change of state of the logical traffic lights at the area of interest, behaviors of the vehicles as the vehicles are approaching or traversing the area of interest.

14. The method of claim 13, further comprising one of:
adjusting, using the at least one processor, a corresponding duration of at least one state of the multiple states based on a result of determining the behaviors of the vehicles.

15. The method of claim 8, further comprising:
changing, using the at least one processor, one or more characteristics of at least one logical traffic light associated with the area of interest based on a change of a state of the area of interest; and
changing, using the at least one processor, one or more properties of at least one physical traffic light corresponding to the at least one logical traffic light based on the change of the one or more characteristics of the at least one logical traffic light.

16. The method of claim 15, wherein changing the one or more properties of the at least one physical traffic light corresponding to the at least one logical traffic light comprises at least one of:
changing a duration of each state of the at least one physical traffic light,
changing a location of the at least one physical traffic light, or
changing a number of the at least one physical traffic light.

17. The method of claim 1, further comprising:
providing data associated with the logical traffic lights that includes the one or more characteristics of the logical traffic lights for visualization using a graphical interface.

18. A method, comprising:
obtaining, using at least one processor, area information of at least one area of interest for a vehicle, wherein the at least one area of interest comprises two or more road blocks, and each road block is associated with a respective logical traffic light representing an aggregation of one or more corresponding physical traffic lights controlling vehicular movement at the road block, and wherein the area information comprises information about logical traffic lights associated with the road blocks in the at least one area of interest;
determining, using the at least one processor, traffic light information associated with a route of the vehicle using the area information of the at least one area of interest, the route comprising at least one road block of the at least one area of interest; and
operating, using the at least one processor, the vehicle along the route using the traffic light information.

19. The method of claim 18, wherein the traffic light information comprises at least one of:
a current state of the at least one area of interest including the at least one road block in the route and a remaining time for the current state of the at least one area of interest, or
a current state of a logical traffic light associated with the at least one road block in the at least one area of interest included in the route, and a remaining time for the current state of the logical traffic light.

20. The method of claim 18, wherein the vehicle is in motion, the method further comprising:
determining, using the at least one processor, that the vehicle is approaching an area of interest in a route traversed by the vehicle,
wherein obtaining the area information of the at least one area of interest is in response to determining that the vehicle is approaching to the area of interest in the route traversed by the vehicle, and
wherein the at least one area of interest comprises a plurality of areas of interest, including the approaching area of interest in the route traversed by the vehicle, and one or more other areas of interest adjacent to the approaching area of interest or in the route traversed by the vehicle.

21. The method of claim 18, further comprising:
obtaining traffic light detection (TLD) data from a traffic light detection system of the vehicle; and
updating the traffic light information based on the TLD data.

22. The method of claim 19, wherein information corresponding to each of the logical traffic lights is obtained based on information of a plurality of corresponding physical traffic lights each configured to control traffic of a respective road block associated with the logical traffic light, and
wherein each of the logical traffic lights comprises a plurality of logical bulbs, wherein the information corresponding to each of the logical traffic lights comprises information of each of the plurality of logical bulbs that includes at least one of shape, color, or state, and wherein each of the plurality of logical bulbs corresponds to respective physical bulbs, among the plurality of corresponding physical traffic lights, that have a same shape, a same color, and a same state.

23. The method of claim 18, wherein the area information of the at least one area of interest comprises at least one of an identifier of the area of interest, an identifier of each of the road blocks in the area of interest, or a list of logical traffic lights, wherein, in the area information, the identifier of the at least one area of interest is associated with multiple states, and wherein each of the multiple states is associated with a respective duration of the state, identifiers of multiple road blocks, and information about a logical traffic light associated with each of the multiple road blocks in the state.

24. The method of claim 23, further comprising:
determining the at least one area of interest to be in a specific state of the multiple states at a specific instant in time, wherein the at least one area of interest is configured to transition from a first state to a second state in a state loop formed by the multiple states at an end of a duration of the first state, and
transitioning the logical traffic lights associated with the area of interest into states corresponding to the second state of the area of interest, together with the area of interest transitioning from the first state to the second state.

25. The method of claim 23, wherein, in the area information, the identifier of the at least one area of interest is associated with one or more trigger events, and
wherein the method comprises: transitioning the at least one area of interest into a corresponding specific state in response to an occurrence of each of the one or more trigger events, and
wherein each of the one or more trigger events is associated with at least one of a distance between the vehicle and the area of interest, or
an expiration of a time period.

26. A system comprising:
at least one processor, and
at least one non-transitory storage medium storing instructions that, when executed by the at least one processor, cause the at least one processor to perform operations comprising:
obtaining information corresponding to an area of interest comprising two or more road blocks, wherein each road block is associated with a plurality of physical traffic lights configured to control traffic movements associated with the road block;
for each of the two or more road blocks, generating a logical traffic light that represents a grouping of the plurality of physical traffic lights; and
determining one or more characteristics of each logical traffic light based on the information corresponding to the area of interest.

27. At least one non-transitory storage media storing instructions that, when executed by at least one processor, cause the at least one processor to perform operations comprising:
obtaining information corresponding to an area of interest comprising two or more road blocks, wherein each road block is associated with a plurality of physical traffic lights configured to control traffic movements associated with the road block;
for each of the two or more road blocks, generating a logical traffic light that represents a grouping of the plurality of physical traffic lights; and
determining one or more characteristics of each logical traffic light based on the information corresponding to the area of interest.
